(19) United States
(12) Patent Application Publication
(10) Pub. No.: US 2014/0000349 A1
(43) Pub. Date: Jan. 2, 2014

(54) IN-LINE MEASURING DEVICES, SYSTEMS, AND METHODS

(71) Applicant: Justin Douglas Swan, North Grosvenor Dale, CT (US)

(72) Inventor: Justin Douglas Swan, North Grosvenor Dale, CT (US)

(73) Assignee: WEBSTONE COMPANY, INC., Worcester, MA (US)

(21) Appl. No.: 13/534,660

(22) Filed: Jun. 27, 2012

(51) Int. Cl. G01N 19/00

(52) U.S. Cl. 73/61.41

(57) ABSTRACT

An in-line measuring device including a connector configured to install the in-line measuring device in a fluidic system. The connector having a first fluid flow path therein. A container having a first end and a second end, wherein the first end is disposed in the connector and in communication with the first fluid flow path. A measuring float is disposed in the container, and a measuring marking is located on the container to indicate a ratio, percent, and/or concentration of fluid within the fluidic system.

### FIELD

The present disclosure relates to devices, systems, and methods for measuring and monitoring concentrations of fluids.

### BACKGROUND

In general, a solar heater or a solar water heater uses sunlight as an energy source to heat fluid. These systems include various piping and tanks to allow for the flow and storage of the fluid used within the system. In cold temperatures, the fluid within the system may freeze due to, for example, mechanical failures, power outages, poor insulation, and other factors. To reduce the risk of freezing of the fluid within the system, antifreeze, for example, propylene glycol or glycol, is commonly introduced into the system, typically in a solar circulation loop of a closed-loop system.

When glycol is introduced into the system, the glycol is typically mixed with distilled water in the system to form a forty (40) percent to a fifty (50) percent, by volume, solution of glycol. However, one drawback of the use of glycol is the leaching out or escape of glycol from the system through pinholes or small gaps in the system, also known as weepage or seepage. Due to the molecular structure of glycol, glycol may leak out of the system where water does not. Another drawback is that over time inhibitors in the glycol can degrade, which can also effect the capability of the fluid within the system to prevent freezing. Thus, the glycol in the system can decrease and degrade over time, which can increase the risk of freezing of the fluid or distilled water within the system.

To ensure the fluid within the system will not freeze, the glycol in the system should be measured periodically. Various devices are currently used to measure the amount of glycol in these systems. One such device is a refractometer, which measures an index of refraction of the fluid or solution being measured. Another device that can be used is a hydrometer, which is used to measure the specific gravity of the fluids in the system. However, both of these devices are stand-alone devices and require a sample of the fluid to be extracted from the system each time the glycol in the system is to be measured.

### SUMMARY

An in-line measuring device for measuring a ratio, percentage, and/or concentration of fluid in a fluidic system is disclosed herein. In general, the in-line measuring device includes an in-line connector having a first side and a second side, and a container coupled to or disposed in the first side of the in-line connector. The container includes one or more measuring markings, and one or more measuring floats are disposed within the container. The measuring float(s) and the measuring marking(s) are configured to correspond to one another to indicate a certain ratio, percentage, and/or concentration of the fluid in the fluidic system when the measuring float(s) substantially aligns with the measuring marking(s).

The in-line measuring device may also include a flange portion coupled to or disposed on the container at an end opposite the in-line connector. The flange portion may include a valve connector, and a bleed-off valve may be coupled to the valve connector. The bleed-off valve allows for the purging of air or other gas and/or fluid within the in-line measuring device, when the in-line measuring device is installed in the fluidic system. One or more fasteners may extend through the flange portion and into the in-line connector to couple the flange portion to the in-line connector. The fasteners may extend between the flange portion and the in-line connector in a position external to the container. This allows the fasteners to protect an exterior of the container from impact and reduce the risk of the container being broken or cracked.

The in-line measuring device may be installed in a solar, geothermal, hydronic, or other circulation loop of the type of a closed-loop or an open-loop system. This allows the in-line measuring device to provide a continuous measurement of the ratio, percentage, and/or concentration of the fluid in the fluidic system, for example, such as a percentage of propylene glycol, glycol, and other anti-freeze fluids in the solar, geothermal, hydronic, or other circulation loop of the type.

### BRIEF DESCRIPTION OF THE DRAWINGS

Embodiments of devices, systems, and methods disclosed herein are illustrated in the figures of the accompanying drawings which are meant to be exemplary and not limiting, in which like references are intended to refer to like or corresponding parts, and in which:

FIG. 1 illustrates a perspective view of an embodiment of in-line measuring device;

FIG. 2 illustrates an exploded view of the in-line measuring device of FIG. 1;

FIG. 3 illustrates a sectional view of the in-line measuring device taken along line A-A of FIG. 1;

FIG. 4 illustrates a perspective view of the in-line measuring device of FIGS. 1-3 coupled to a valve;

FIG. 5 illustrates a perspective view of the in-line measuring device of FIGS. 1-3 coupled to a purge or bypass valve;

FIG. 6 illustrates a block flow diagram of installing the in-line measuring device in a fluidic system; and

FIG. 7 illustrates the in-line measuring device of FIGS. 1-3 installed in a fluidic system.

### DETAILED DESCRIPTION

Detailed embodiments of in-line measuring devices, systems, and methods for installation and use are disclosed herein, however, it is to be understood that the disclosed embodiments are merely exemplary of the devices, systems, and methods, which may be embodied in various forms. Therefore, specific functional details disclosed herein are not to be interpreted as limiting, but merely as a basis for the claims and as a representative basis for teaching one skilled in the art to variously employ the devices, systems, and methods disclosed herein.

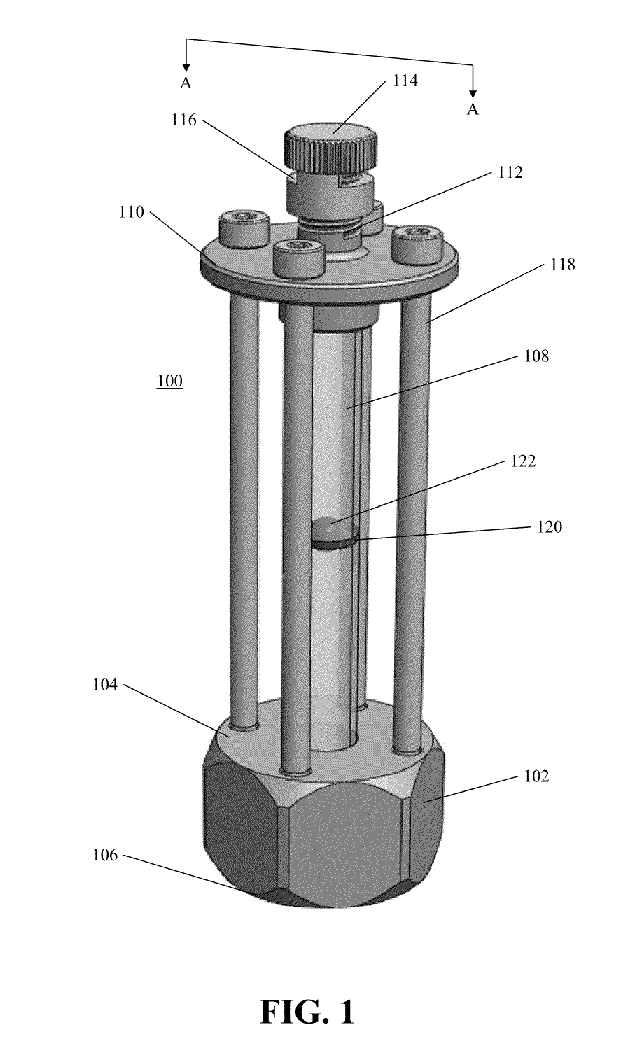

A perspective view of an in-line measuring device 100 according to an illustrative embodiment is described with reference to FIG. 1. As illustrated in FIG. 1, the in-line measuring device 100 includes an in-line connector 102 having a first side 104 and a second side 106, and a container or a measuring chamber 108 extending from the first side 104 of the in-line connector 102. As illustrated in FIG. 1, the container 108 is a hollow cylindrical container or measuring chamber having a fluid flow path therein. The second side 106 of the in-line connector 102 is configured to couple or install the in-line measuring device 100 to a fluidic system to allow for fluid communication between the fluidic system and the container 108. The in-line connector 102 may also be configured to engage a tool, for example, a wrench, to allow torque to be applied to the in-line connector 102 when coupling or installing the in-line measuring device 100 to the fluidic system.

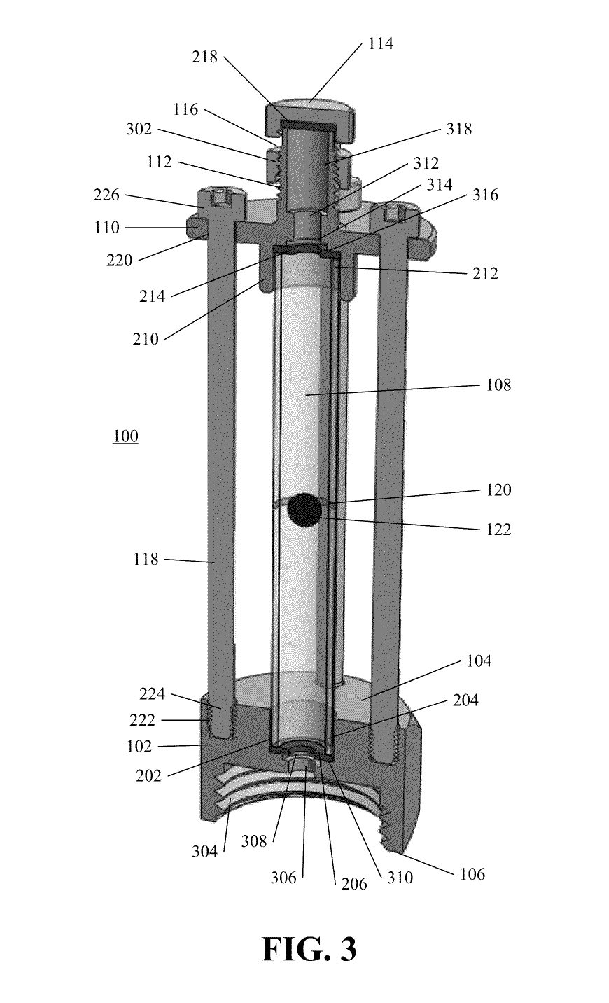

The in-line measuring device 100 may also include a flange portion 110. The flange portion 110 is disposed on the container 108 at an end distal to the in-line connector 102. As illustrated in FIG. 1, the flange portion 110 includes an aperture (318, described hereinafter with reference to FIG. 3), that is in fluid communication with the container 108, and includes a valve connector 112. A valve 114 is coupled to the valve connector 112 and includes one or more valve apertures or valve slots 116. The valve 114 allows for the bleed-off of air and/or fluid within the in-line measuring device 100, for example, when the in-line measuring device 100 is being installed in the fluidic system.

The flange portion 110 may be coupled to the in-line connector 102 by one or more fasteners 118. As illustrated in FIG. 1, there are four (4) fasteners 118, and the fastener(s) 118 extend through the flange portion 110 and into the in-line connector 102. The fastener(s) 118 may also serve to protect the container 108 from impact and reduce the risk of the container 108 being broken or cracked.

The container 108 may also include one or more measuring markings 120. One or more measuring floats 122 are disposed within the container 108. The measuring float(s) 122 and the measuring marking(s) 120 are configured to correspond to one another, for example, the measuring marking(s) 120 can be configured to indicate about a fifty (50) percent, by volume, solution of glycol and water, and the measuring float(s) 122 can be configured to be substantially aligned with the measuring marking(s) 120 when the fluid within the fluidic system is a about fifty (50) percent, by volume, solution of glycol and water.

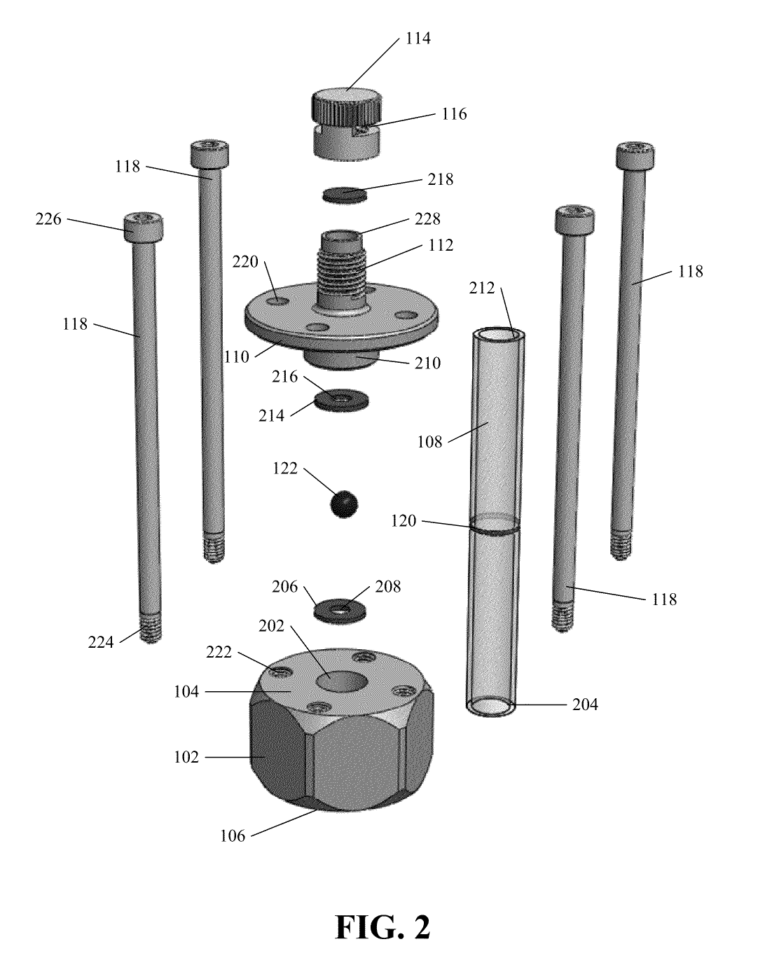

An exploded view of the in-line measuring device 100 is described with reference to FIG. 2. As illustrated in FIG. 2, the in-line connector 102 includes a first container receiving portion 202 in the first side 104 of the in-line connector 102. The first container receiving portion 202 extends from the first side 104 of the in-line connector 102 at least a portion of the way into the in-line connector 102 towards the second side 106 of the in-line connector 102. The first container receiving portion 202 is configured to receive a first end 204 of the container 108. A first gasket 206 having an aperture 208 may be disposed within the first container receiving portion 202 to provide a fluid tight seal between the first end 204 of the container 108 and the first container receiving portion 202.

Similarly, the flange portion 110 includes a second container receiving portion 210 configured to receive a second end 212 of the container 108. A second gasket 214 having an aperture 216 may be disposed within the second container receiving portion 210 to provide a fluid tight seal between the second end 212 of the container 108 and the second container receiving portion 210.

As illustrated in FIG. 2, the valve connector 112 of the flange portion 110 is a threaded male connector configured to be received by a corresponding or mating threaded female connector (illustrated in FIG. 3, as 302) of the valve 114. A gasket 218 may be disposed within the valve 114 to provide a fluid tight seal between the valve 114 and the valve connector 112 when the valve 114 is tightened onto the valve connector 112. The flange portion 110 may also include one or more fastener apertures 220 configured to receive the one or more fasteners 118. The in-line connector 102 may also include one or more fastener connections 222 on or in the first side 104 of the in-line connector 102 configured to receive a connection end 224 of the fastener(s) 118. As illustrated in FIG. 2, the fastener connection(s) 222 is a threaded female connection and the connection end 224 of the fastener(s) 118 is a corresponding or mating threaded male connection. The fastener(s) 118 also includes a head(s) 226 configured to receive a bit of a tool, for example, to allow torque to be applied to the fastener(s) 118.

A sectional view of the in-line measuring device 100 is described with reference to FIG. 3. As illustrated in FIG. 3, the in-line connector 102 includes a threaded female connection 304 in the second side 106 of the in-line connector 102. The threaded female connection 304 is configured to receive a corresponding threaded male connection of a valve or other piping in the fluidic system in which the in-line measuring device 100 is to be installed.

The first container receiving portion 202 in the first side 104 of the in-line connector 102 has a first cross-sectional area to a first depth within the in-line connector 102. An aperture or fluid flow path 306 extends between the threaded female connection 304 in the second side 106 of the in-line connector 102 and the first container receiving portion 202 in the first side 104 of the in-line connector 102. The fluid flow path 306 has a second cross-sectional area smaller than the first cross-sectional area of the first container receiving portion 202 to a depth from the threaded female connection 304. The fluid flow path 306 may also have a third cross-sectional area proximal to the first container receiving portion 202 smaller than the first cross-sectional area of the first container receiving portion 202 and larger than the second cross-sectional area of the fluid flow path 306 forming a screen receiving portion 308 between the second cross-sectional area of the fluid flow path 306 and the first container receiving portion 202. The screen receiving portion 308 may receive a screen or filtering device configured to filter out debris and other unwanted particles, for example, rust particles, from entering the container 108. The screen or filtering device may also prevent the one or more measuring floats 122 in the container 108 from exiting or escaping the container 108.

The intersection of the first container receiving portion 202 and the screen receiving portion 308 forms a stop 310. The stop 310 prevents the first gasket 206 and the container 108 from passing through the in-line connector 102. The stop 310 also allows the first gasket 206 to provide a fluid tight seal between the container 108 and the stop 310 within the first container receiving portion 202. It should be appreciated that the screen receiving portion 308 is optional. Further, it should be appreciated that in one embodiment, in the absence of the screen receiving portion 308 the fluid flow path 306 extends to the first container receiving portion 202, and the intersection of the first container receiving portion 202 and the fluid flow path 306 forms the stop 310. In a second embodiment, the in-line connector 102 includes an integral or monolithically formed screen that replaces the screen receiving portion 308. In this second embodiment, it should be appreciated that the fluid flow path 306 and the first container receiving portion 202 each extend to opposite sides, respectively, of the integral screen, and the intersection of the first container receiving portion 202 and the integral screen forms the stop 310.

As illustrated in FIG. 3, the fluid flow path 306 and the screen receiving portion 308 are substantially aligned with a center of the first container receiving portion 202. The aperture 208 in the first gasket 206 is also substantially aligned with the fluid flow path 306, the screen receiving portion 308, and the center of the first container receiving portion 202. This allows for fluid flow between the second side 106 of the in-line connector 102 and the container 108.

Similarly, the second container receiving portion 210 of the flange portion 110 has a first cross-sectional area to a first depth. An aperture or fluid flow path 312 extends between the second container receiving portion 210 and the valve connector 112 of the flange portion 110. The fluid flow path 312 has a second cross-sectional area smaller than the first cross-sectional area of the second container receiving portion 210. The fluid flow path 312 may also have a third cross-sectional area proximal to the second container receiving portion 210 smaller than the first cross-sectional area of the second container receiving portion 210 and larger than the second cross-sectional area of the fluid flow path 312 forming a screen receiving portion 314 between the second cross-sectional area of the fluid flow path 312 and the second container receiving portion 210. The screen receiving portion 314 may receive a screen or filtering device, for example, as described hereinbefore.

The intersection of the second container receiving portion 210 and the screen receiving portion 314 forms a stop 316. The stop 316 prevents the second gasket 214 and the container 108 from passing through the flange portion 110. The stop 316 also allows the second gasket 214 to provide a fluid tight seal between the container 108 and the stop 316 within the second container receiving portion 210. As described hereinbefore, it should be appreciated that the screen receiving portion 314 is optional, and that the fluid flow path 312 may extend to the second container receiving portion 210, and the intersection of the second container receiving portion 210 and the fluid flow path 312 forms the stop 316. Further, an integral or monolithically formed screen can replace the screen receiving portion 314, as described hereinbefore.

In an illustrative embodiment, the second cross-sectional area of the fluid flow path 306 of the in-line connector 102 and the second cross-sectional area of the fluid flow path 312 of the flange portion 110 are configured to be smaller than a cross-sectional area of the one or more measuring floats 122 that are disposed within the container 108. This prevents the one or more measuring floats 122 from falling out of, being removed from, escaping, or inadvertently exiting the container 108.

Referring to FIG. 3, the valve connector 112 of the flange portion 110 may include an aperture or fluid flow path 318 that extends from the fluid flow path 312 to an end 228 (illustrated in FIG. 2) of the valve connector 112. The fluid flow path 318 allows fluid to flow through the container 108 and out of the valve connector 112 or through the valve slot(s) 116 in the valve 114 when the valve 114 is in a first position or open position. This allows for air or other gases and fluid to be purged or bled off during installation of the in-line measuring device 100 in the fluidic system. When the valve 114 is in a second position or closed position, the gasket 218 is compressed between the end 228 of the valve connector 112 and an inside of the valve 114 creating a fluid tight seal and preventing fluid flow out of the valve connector 112 and through the valve slot(s) 116 in the valve 114.

As illustrated in FIG. 3, the fluid flow path 312 and the screen receiving portion 314 are substantially aligned with a center of the second container receiving portion 210. The aperture 216 in the second gasket 214 is also substantially aligned with the fluid flow path 312, the screen receiving portion 314, and the center of the second container receiving portion 210. This allows for fluid flow between the container 108 and the valve connector 112.

As illustrated in FIG. 3, the first gasket 206 is disposed in the first container receiving portion 202 of the in-line connector 102 abutting the stop 310, and the first end 204 of the container 108 is disposed in the first container receiving portion 202 of the in-line connector 102 abutting first gasket 206. Similarly, the second gasket 214 is disposed in the second container receiving portion 210 of the flange portion 110 abutting the stop 316, and the second end 212 of the container 108 is disposed in the second container receiving portion 210 of the flange portion 110 abutting second gasket 214.

The fastener(s) 118 extend through the fastener aperture(s) 220 in the flange portion 110 and the connection end(s) 224 of the fastener(s) 118 are mated with the fastener connection(s) 222 of the in-line connector 102. The head(s) 226 of the fastener(s) 118 have a larger cross-sectional area than a cross-sectional area of the fastener aperture(s) 220 in the flange portion 110 to prevent the head(s) 226 of the fastener(s) 118 from passing through the fastener aperture(s) 220. The head(s) 226 of the fastener(s) 118 exert a force or pressure on the flange portion 110 in the direction of the in-line connector 102 and/or the connection end(s) 224 of the fastener(s) 118 exert a force or pressure on the in-line connector 102 in the direction of the flange portion 110.

The fastener connection(s) 222 of the in-line connector 102 and the connection end(s) 224 of the fastener(s) 118 are configured to allow the connection end(s) 224 of the fastener(s) 118 to bottom out in the fastener connection(s) 222 of the in-line connector 102 at a pressure or force to provide a fluid tight seal between the container 108 and the in-line connector 102, and the container 108 and the flange portion 110 without breaking, fracturing, cracking, or compromising the structural integrity of the container 108.

As illustrated in FIGS. 1-3, the flange portion 110 and the in-line connector 102 have a cross-sectional area larger than that of the container 108. The fastener connection(s) 222 and the fastener aperture(s) 220 are positioned or located on the flange portion 110 and the in-line connector 102 outside of the cross-sectional area of the container 108. This allows the fastener(s) 118 to be disposed, positioned, or located around the container 108 to provide the pressure described hereinbefore and protect the container 108 from impact and reduce the risk of the container 108 being broken or cracked.

In an illustrative embodiment, when the in-line measuring device 100 is installed in the fluidic system, fluid within the system fills the container 108. The in-line measuring device 100 may be configured to measure the amount, ratio, or concentration of certain fluids within the fluidic system, for example, using the specific gravity or relative density of certain fluids, for example, such as propylene glycol, glycol, other anti-freeze fluids, and alcohol. In one example, the in-line measuring device 100 may be configured to measure a percentage of glycol, by volume, in water. In this illustrative embodiment, the measuring float 122, illustrated in FIG. 1, is configured or designed to have a weight that allows the measuring float 122 to be positioned in a center of the container 108, between the flange portion 110 and the in-line connector 102, when the fluid within the container 108 is about a fifty (50) percent, by volume, solution of glycol and water. The measuring marking 120, illustrated in FIG. 1, is positioned in the center of the container 108, between the flange portion 110 and the in-line connector 102, to indicate about a fifty (50) percent, by volume, solution of glycol and water when the measuring float 122 is aligned with the measuring marking 120.

It should be appreciated that additional measuring markings 120 may be on the container 108, to indicate alternative amounts, ratios, or concentrations of certain fluids within the fluidic system, for example, to indicate about a twenty (20) percent, thirty (30) percent, forty (40) percent, sixty (60) percent, or other percent including all percentages therebetween, by volume, solution of glycol and water when the measuring float 122 aligns with one of the measuring markings 120. In one example, as the measuring float 122 moves closer to the in-line connector 102, the measuring markings 120 may indicate that the amount of glycol present in the fluidic system is higher or lower than about fifty (50) percent by volume, depending on the orientation of the in-line measuring device 100 with respect to the force of gravity. Similarly, as the measuring float 122 moves closer to the flange portion 110, the measuring markings 120 may indicate that the amount of glycol present in the fluidic system is higher or lower than about fifty (50) percent by volume, depending on the orientation of the in-line measuring device 100 with respect to the force of gravity.

Further, it should be appreciated that there may be more than one measuring float 122, the measuring float 122 and the measuring marking 120 may be configured to measure or indicate amounts, ratios, or concentrations of numerous different types of fluids, and/or the measuring markings 120 indicate certain amounts, ratios, or concentrations at various locations along the container 108.

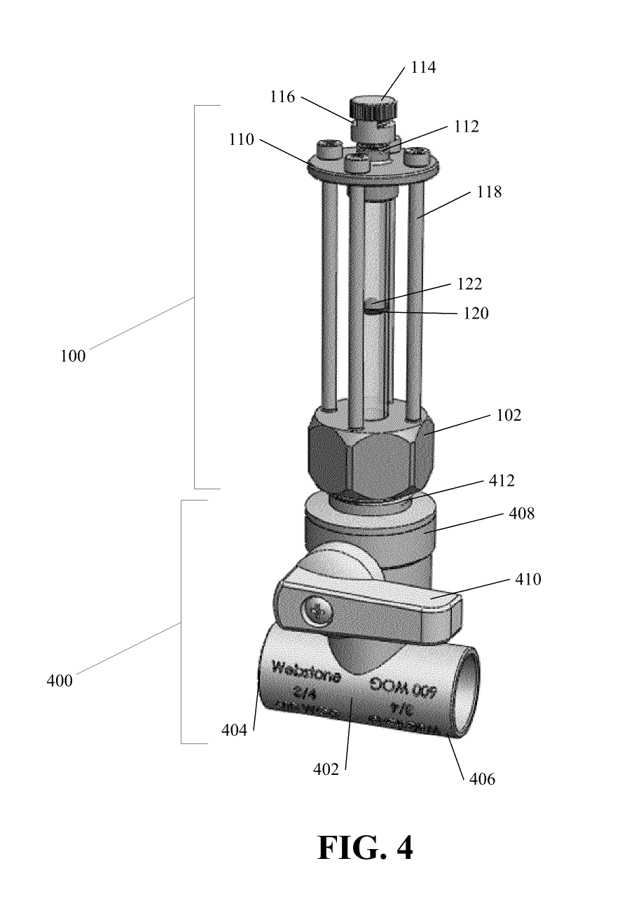

In an illustrative embodiment, the in-line measuring device 100 may be coupled in one or more valve configurations. A perspective view of the in-line measuring device 100 coupled to a single valve 400 is described with reference to FIG. 4. The valve 400 is a “T” valve including a valve body 402 having a first fluid flow port 404 and a second fluid flow port 406 in fluid communication with the first fluid flow port 404 through a first fluid flow path. As illustrated the first fluid flow port 404 and the second fluid flow port 406 are aligned with one another. The valve body 402 also includes a third fluid flow port 408 extending from the valve body and perpendicular to the first fluid flow port 404 and the second fluid flow port 406. The third fluid flow port 408 is in fluid communication with the first fluid flow port 404 and the second fluid flow port 406 through a second fluid flow path. A flow diversion device coupled to an actuator 410 is disposed in the third fluid flow port 408.

As illustrated in FIG. 4, the third fluid flow port 408 includes a threaded male connection 412. The threaded female connection 304 in the second side 106 of the in-line connector 102 is coupled to the threaded male connection 412. This allows fluid communication between the in-line measuring device 100 and the valve 400 through the third fluid flow port 408 of the valve 400. The flow diversion device of the valve 400 can be configured between a first position or open position and a second position or closed position by rotating the actuator 410. In the first position, the in-line measuring device 100 is in fluid communication with the first fluid flow port 404, the second fluid flow port 406, and the third fluid flow port 408. In the second position, the in-line measuring device 100 is removed from fluid communication with the first fluid flow port 404, the second fluid flow port 406, and the third fluid flow port 408. The second position allows for the in-line measuring device 100 to be installed or removed from connection to the valve 400.

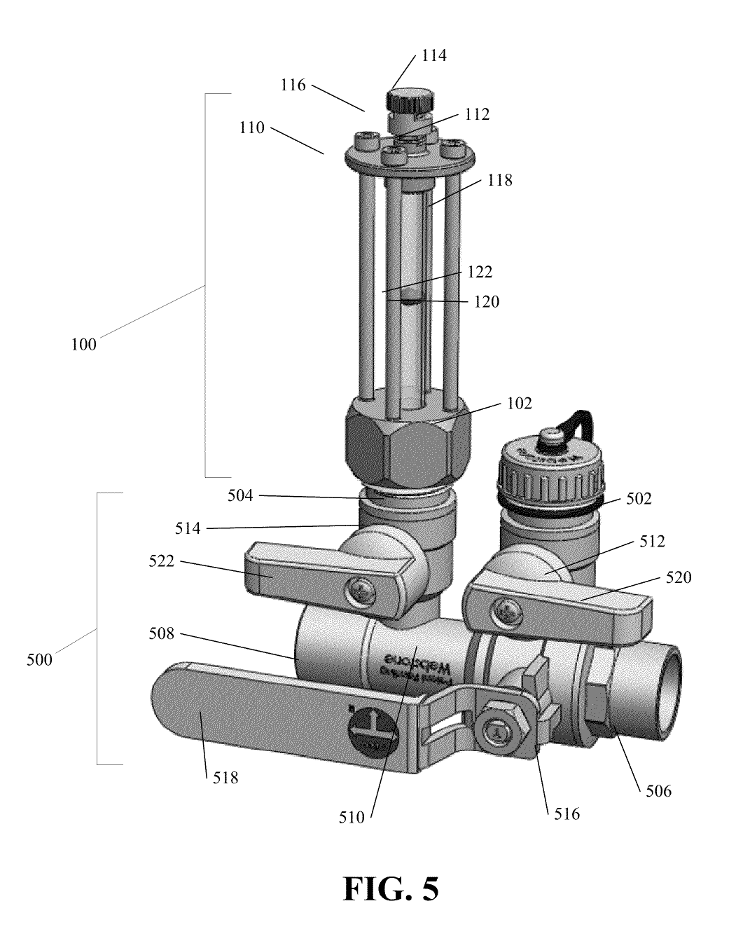

In another illustrative embodiment, the in-line measuring device 100 may be coupled in an alternative valve configuration. A perspective view of the in-line measuring device 100 coupled to a purge or bypass valve 500 is described with reference to FIG. 5. The purge or bypass valve 500 may be a primary/secondary loop purge valve, such as described in U.S. Patent Application Publication No. 2011/0163171 (U.S. patent application Ser. No. 12/836,248), entitled PRIMARY/SECONDARY PIPING LOOP INTERFACE APPARATUS, the contents of which are incorporated herein by reference in their entirety. In this illustrative embodiment, the bypass valve 500 includes a valve body containing a first fluid flow port 502, a second fluid flow port 504, a first loop port 506 and a second loop port 508. The first and second loop ports 506 and 508 are disposed at respective ends of a linear portion 510 of the valve body. A first valve 512 disposed between the first fluid flow port 502 and the linear portion 510, and a second valve 514 is disposed between the second fluid flow port 504 and the linear portion 510. A main valve 516 is disposed in the linear portion 510 in alignment with the first valve 512 and the first fluid flow port 502.

The valve 516 includes a main actuator 518 allowing the valve 516 to be configured between a first position or open position and a second position or closed position. Similarly, the first valve 512 includes a first actuator 520 and the second valve 514 includes a second actuator 522. The first actuator 520 and the second actuator 522 allow the first valve 512 and the second valve 514, respectively, to be configured between a first position or open position and a second position or closed position. It should be appreciated that each of or all of the ports 502, 504, 506, and 508 may be placed in or removed from fluid communication with one another by positioning the actuators 518, 502 and 522 in their respective first and/or second positions.

As illustrated in FIG. 5, the threaded female connection 304 in the second side 106 of the in-line connector 102 is coupled to a threaded male connection of the second fluid flow port 504. This allows fluid communication between the in-line measuring device 100 and the valve 500 through the second fluid flow port 504 of the valve 500.

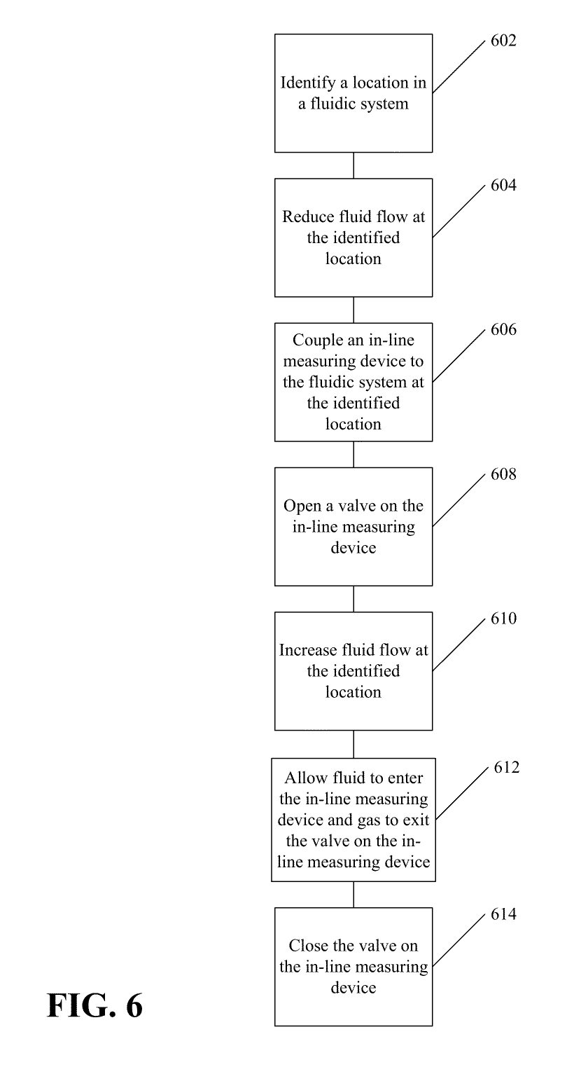

A block flow diagram of a method of installing the in-line measuring device 100 in a fluidic system according to an illustrative embodiment is described with reference to FIG. 6. The method may include selecting or identifying 602 a location with the fluidic system where an amount, ratio, or concentration of a fluid within the fluidic system is to be measured. The flow of the fluid through the fluidic system in the identified location may be reduced, 604, for example, by actuating one or more valves in the fluidic system to close or stop fluid flow in the identified location. The in-line measuring device 100 can be coupled 606 to the fluidic system in the identified location, for example, by threading the in-line measuring device 100 onto a pipe, valve, or other component of the fluidic system. The valve 114 on the in-line measuring device 100 may be in actuated or opened 608 to place the valve 114 in the first position or open position. The flow of the fluid through the fluidic system in the identified location may be increased, 610, for example, by actuating one or more valves in the fluidic system to allow fluid flow in the identified location.

With the valve 114 on the in-line measuring device 100 in the first position, fluid within the fluidic system is allowed 612 to flow into the in-line measuring device 100. When the fluid is allowed 612 to flow into the in-line measuring device 100, the valve 114 permits air or other gasses and fluid to be purged from or bled off the in-line measuring device 100, for example, via the apertures 116 of the valve 114. Once the in-line measuring device 100 is filled with the fluid and the air or other gasses are purged, the valve 114 may be closed 614, for example, by actuating or closing the valve 114 to place the valve 114 in the second position or closed position. With the in-line measuring device 100 installed in the fluidic system, the ratio, or concentration of the fluid within the fluidic system can be continuously measured and monitored.

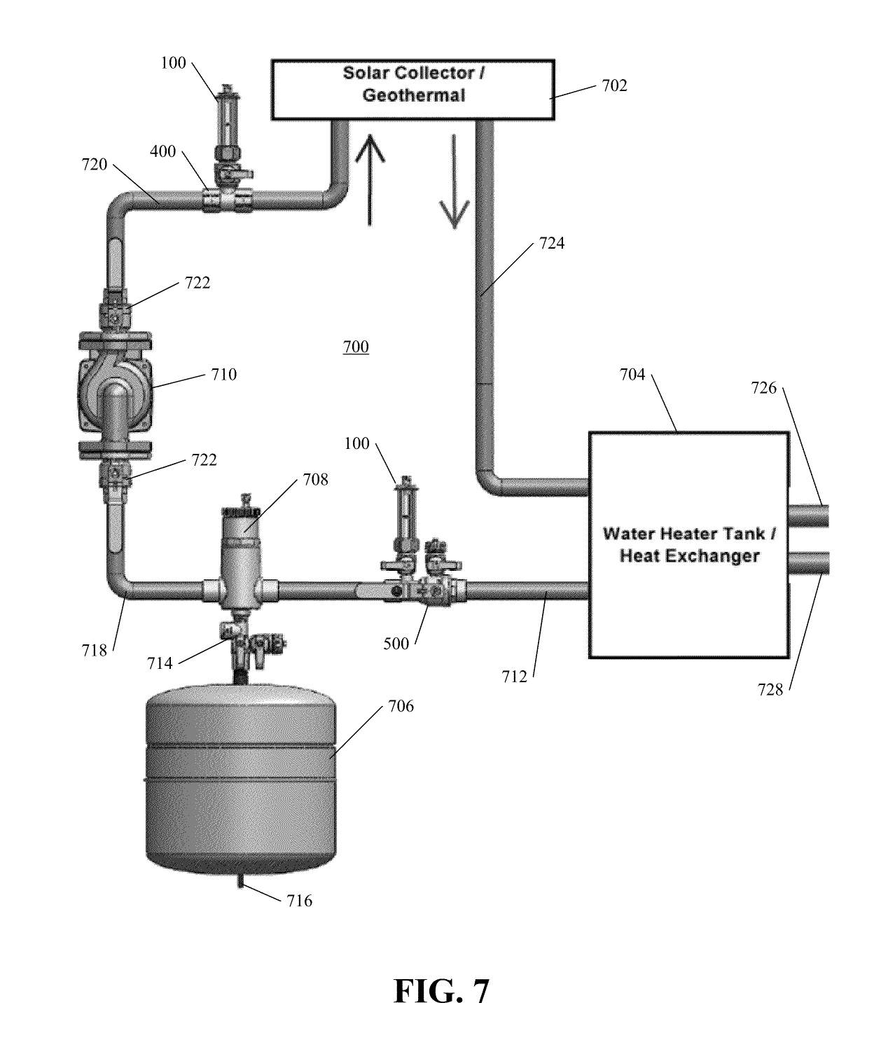

The in-line measuring device 100 installed in a fluidic system according to an illustrative embodiment is described with reference to FIG. 7. As illustrated in FIG. 7, the fluidic system is a solar or geothermal fluidic heating system 700. For illustrative purposes, the system is described as the solar heating system 700 including a solar collector 702 for collecting heat by absorbing sunlight. However, in a geothermal heating system a geothermal heater that uses, for example, the sub-surface temperature of the earth as a heat source may be used instead of the solar collector 702.

In this illustrative embodiment, the solar heating system 700 includes the solar collector 702, a heat exchanger or a water heater 704, an expansion tank 706, an air separator 708, and a pump 710 connected via various piping. A first fluid, for example, a solution of glycol and water, flows through or is circulated within the solar heating system 700 by the pump 710. The first fluid flows through outlet piping 712 of the heat exchanger 704 and through the air separator 708 in fluid communication with the outlet piping 712 and designed to remove entrained air from the first fluid. As illustrated, the expansion tank 706 is in fluid communication with the air separator 708, via a valve 714, and is designed to stabilize the pressure within the closed-loop of the solar heating system 700. The expansion tank 706 may also include a release valve or pressure relief valve 716 to reduce the risk of the expansion tank 706 or the closed-loop of the solar heating system 700 becoming over-pressured as the first fluid within the closed-loop is heated and cooled.

The first fluid flows from the air separator 708, through piping 718, through the pump 710 in fluid communication with the piping 718, and into the solar collector 702 via piping 720. As illustrated, the pump 710 is connected to the piping 718 and the piping 720 via valves 722 having flange connections. Within the solar collector 702, the first fluid is heated. The heated first fluid flows out of the solar collector 702, which is upstream of the heat exchanger 704, and into the heat exchanger 704, via inlet piping 724. A second fluid, for example, water of a plumbing system, flows into the heat exchanger 704 via an inlet 726, and is heated by the heated first fluid flowing into the heat exchanger 704. The heated water then flows out of the heat exchanger 704 via an outlet 728 and into the plumbing system.

In this illustrative embodiment, the solar heating system 700 is a closed-loop system that heats the first fluid flowing through the closed-loop and transfers the heat from the first fluid to the second fluid. As described above, the first fluid flowing through the closed-loop of the solar heating system 700 may include an anti-freeze, for example, glycol or propylene glycol to reduce the risk of freezing of the first fluid.

The in-line measuring device 100 may be installed within the closed-loop of the solar heating system 700 to continuously measure the amount, ratio, or concentration of glycol or propylene glycol within the closed-loop. As illustrated in FIG. 7, the in-line measuring device 100 is installed in the outlet piping 712 between the heat exchanger 704 and the air separator 708, and in the piping 720 between the pump 710 and the solar collector 702. The in-line measuring device 100 installed in the outlet piping 712 is installed using the purge or bypass valve 500. The purge or bypass valve 500 allows for the flow of the first fluid to the in-line measuring device 100 to be shut-off and the in-line measuring device 100 to be removed, for replacing, cleaning, or otherwise servicing the in-line measuring device 100. The purge or bypass valve 500 also includes the first fluid flow port 502 which allows for the draining, flushing, and filling of the closed-loop of the solar heating system 700. The in-line measuring device 100 installed in the outlet piping 720 is installed using the “T” valve or the single valve 400. The single valve 400 also allows for the flow of the first fluid to the in-line measuring device 100 to be shut-off and the in-line measuring device 100 to be removed, for replacing, cleaning, or otherwise servicing the in-line measuring device 100.

Although the in-line measuring device 100 is described as being installed in the system 700 using certain valves and at certain locations, it should be appreciated that the in-line measuring device 100 may be directly installed in the system 700 without an intermediary valve, installed using other valve configurations, and may be installed at any number of various locations where the amount, ratio, or concentration of the first fluid within the system 700 is desired to be identified. For example, the in-line measuring device 100 may be installed in one or more of the piping 712, the piping 718, the piping 720, the piping 724, and other locations within the system 700.

In an illustrative embodiment, the in-line measuring device 100 may be installed in the fluidic system in an angular orientation that is about 0 degrees to about 45 degrees, including all points and sub-ranges therebetween, relative to the force of gravity, wherein 0 degrees is the orientation of the in-line measuring device 100 when the force of gravity is in a direction parallel to a longitudinal axis of the container 108.

Although the devices, systems, and methods are described and illustrated in connection with certain embodiments, many variations and modifications can be made without departing from the spirit and scope of the disclosure.

In some embodiments, the in-line measuring device may include less than four (4) or more than four (4) fasteners. The in-line measuring device may not include any fasteners, and the container may be threaded into the in-line connector and/or the flange portion. The container may have a closed second end, and thus may not include the flange portion or the fasteners. The valve on the flange portion for purging gas from the in-line measuring device is optional and may not be included in all embodiments. For example, the flange portion may not have a fluid flow path and may merely act as a cap to close the container. Additionally, it should be appreciated that various other types of bleed-off valves and other valves of the type can be incorporated in the in-line measuring device. Although certain components are described herein as including threaded female or threaded male connections, it should be appreciated that any of the connections may be threaded female connections, threaded male connections, union connections, or flange connections.

Although the container is described as having a cylindrical shape, it should be appreciated that the container may have any of various geometric shapes, for example, a spherical or globe shape, a hexahedron shape, a tetrahedron shape, a octahedron shape, a icosahedron shape, a dodecahedron shape, and other three dimensional geometric shapes. It should also be appreciated that various geometric shapes may allow the in-line measuring device to be installed in the fluidic system in an angular orientation that is about 0 degrees to about 90 degrees, including all points and sub-ranges therebetween, relative to the force of gravity. In one example, the container is a spherical or globe shape. In this example, the container may include one or more protruding connection portions that allow the container to be coupled to or disposed in the in-line connector and/or the flange portion. Further, the spherical shape of the container may allow the container to provide accurate measurements when the container is oriented in any of the angular orientations.

In an embodiment, the container may include a multiplicity of measuring markings. The measuring markings may include words, numbers, shapes, symbols, and other markings that indicate certain amounts, ratios, or concentrations of certain fluids within the fluidic system. There may also be multiple measuring floats within the container. The measuring markings and the measuring floats may be color coded to correspond to one another for measuring purposes. The color(s) may also be used in connection with certain fluids, for example, read may be used to identify the measuring marking(s) and the corresponding measuring float(s) that measures glycol and another color may be used to identify the measuring marking(s) and the corresponding measuring float(s) that measures a different fluid or component of the fluid. Further, it should be appreciated that the size, shape, and weight of the measuring floats can be varied, for example, the measuring floats may have a spherical shape, a disc or circle shape, a square shape, a triangular shape, and other geometric shapes or the type.

One or more of the components of the in-line measuring device may be constructed or made of one or more metals; for example, brass, copper, iron, and stainless steel; plastics or polymers, for example, polyvinyl chloride (PVC) and cross-linked polyethylene (PEX); glass; or other materials of the type. In one embodiment, the container is made out of a clear polymer, which allows for the measuring floats to be easily visible within the container. Further, it should be appreciated that the in-line measuring device may be monolithically formed as a single piece including at least the container and the in-line connector. By forming or fabricating the in-line measuring device as a monolithic structure, the risk of leaking between the various components should be reduced.

Although the devices, systems, and methods are described and illustrated in connection with certain embodiments, additional variations and modifications will be evident to those skilled in the art and may be made without departing from the spirit and scope of the disclosure. The disclosure is thus not to be limited to the precise details of methodology or construction set forth above as such variations and modification are intended to be included within the scope of the disclosure. Moreover, unless specifically stated any use of the terms first, second, etc. do not denote any order or importance, but rather the terms first, second, etc. are merely used to distinguish one element from another.

What is claimed is:

1. An in-line measuring device, comprising:
a connector having a first fluid flow path;
a container having a first end and a second end, said first end disposed in said connector and in communication with said first fluid flow path;
a measuring float disposed in said container; and
a measuring marking on said container.

2. The in-line measuring device of claim 1, further comprising a flange portion having a second fluid flow path, said second end of said container disposed in said flange portion and in communication with said second fluid flow path.

3. The in-line measuring device of claim 2, further comprising a fastener extending between said flange portion and said connector and coupling said flange portion to said connector.

4. The in-line measuring device of claim 2, wherein said flange portion includes a valve connector on a side of said flange portion opposite said container, said valve connector including a third fluid flow path in communication with said second fluid flow path.

5. The in-line measuring device of claim 4, further comprising a bleed-off valve coupled to said valve connector.

6. The in-line measuring device of claim 5, wherein said bleed-off valve includes an aperture configured to be in fluid communication with said third fluid flow path when said bleed-off valve is in an open position.

7. The in-line measuring device of claim 1, further comprising a “T” valve coupled to a side of said connector opposite said container, said “T” valve in communication with said first fluid flow path.

8. The in-line measuring device of claim 1, further comprising a bypass valve coupled to a side of said connector opposite said container, said bypass valve in communication with said first fluid flow path.

9. An in-line measuring device, comprising:
a valve body defining a first fluid flow path;
a container having a first end and a second end, said first end coupled to said valve body and in communication with said first fluid flow path; and
a measuring float disposed in said container.

10. The in-line measuring device of claim 9, wherein said valve body includes:
a first fluid flow port;
a second fluid flow port in axial alignment with said first fluid flow port; and
a third fluid flow port perpendicular to said first fluid flow port and said second fluid flow port,
said first fluid flow port, said second fluid flow port, and said third fluid flow port in communication with said first fluid flow path, and
said container coupled to said third fluid flow port.

11. The in-line measuring device of claim 10, wherein said valve body includes a flow diversion device disposed in said third fluid flow port, and adapted to be actuated between an open position and a closed position.

12. The in-line measuring device of claim 9, wherein said valve body includes:
a linear portion
a first loop port at a first end of said linear portion;
a second loop port at a second end of said linear portion;
a first fluid flow port extending from said linear portion; and
a second fluid flow port extending from said linear portion, said container coupled to said second fluid flow port.

13. The in-line measuring device of claim 12, wherein said valve body includes a first valve disposed in said valve body between said first fluid flow port and said linear portion, and adapted to be actuated between an open position and a closed position.

14. The in-line measuring device of claim 13, wherein said valve body includes a second valve disposed in said valve body between said second fluid flow port and said linear portion, and adapted to be actuated between an open position and a closed position.

15. The in-line measuring device of claim 14, wherein said valve body includes a main valve disposed in said linear portion of said valve body.

16. A system, comprising:
a water heater adapted to be connected in fluid communication with a closed-loop of a fluidic heating system; and
an in-line measuring device adapted to couple to and be in fluid communication with said closed-loop of said fluidic heating system, said in-line measuring device including:
a connector having a first fluid flow path adapted to be in fluid communication with said closed-loop of said fluidic heating system;
a container having a first end and a second end, said first end disposed in said connector and in fluid communication with said first fluid flow path; and
a measuring float disposed in said container.

17. The system of claim 16, wherein said in-line measuring device includes a valve body, said valve body adapted to couple to and be in fluid communication with said closed-loop of said fluidic heating system, and said valve body coupled to said connector opposite said container.

18. The system of claim 16, wherein said measuring float is adapted to be positioned at about a center of said container when said closed-loop of said fluidic heating system includes about a fifty percent, by volume, solution of glycol and water.

19. The system of claim 16, further comprising a solar collector adapted to be connected in fluid communication with said closed-loop of said fluidic heating system upstream of said water heater.

20. The system of claim 19, further comprising a pump adapted to be connected in fluid communication with said closed-loop of said fluidic heating system, and circulate a fluid within said closed-loop of said fluidic heating system.
